(19) United States
(12) Patent Application Publication
(10) Pub. No.: US 2020/0326706 A1
(43) Pub. Date: Oct. 15, 2020

(54) SYSTEMS AND METHODS FOR LOCALIZING AERIAL VEHICLE USING UNMANNED VEHICLE

(71) Applicant: General Electric Company, Schenectady, NY (US)

(72) Inventors: John Robert Hoare, Latham, NY (US); Justin Foehner, Niskayuna, NY (US); Steven Robert Gray, Niskayuna, NY (US); Yewteck Tan, Schenectady, NY (US)

(21) Appl. No.: 16/845,611

(22) Filed: Apr. 10, 2020

Related U.S. Application Data
(60) Provisional application No. 62/832,113, filed on Apr. 10, 2019.

(51) Int. Cl. G05D 1/00; B64C 39/02; B60K 1/00; B60R 11/04; B64D 47/02; G05D 1/10; G01C 21/20; G08G 5/00

(52) U.S. Cl. CPC G05D 1/0088; B64C 39/024; B60K 1/00; B60R 11/04; B64D 47/02; B64C 2201/141; G01C 21/206; G08G 5/0034; G08G 5/0013; G08G 5/0069; B64C 2201/027; G05D 1/101

(57) ABSTRACT

A system includes at least one unmanned aerial vehicle and at least one unmanned vehicle communicatively coupled to the unmanned aerial vehicle. The unmanned aerial vehicle includes a propulsion system and an onboard pilot system configured to determine a flight path for the unmanned aerial vehicle. The unmanned vehicle includes a propulsion system and a localization system configured to determine a location of the unmanned aerial vehicle relative to the unmanned vehicle. The unmanned vehicle further includes a communication component configured to transmit location information to the unmanned aerial vehicle. The onboard pilot system is configured to determine the flight path based on the location information provided by the unmanned vehicle.

### CROSS-REFERENCE TO RELATED APPLICATIONS

This application claims priority to U.S. Provisional Patent Application Ser. No. 62/832,113, filed on Apr. 10, 2019, the disclosure of which is hereby incorporated by reference in its entirety.

### BACKGROUND

The field of the disclosure relates generally to a system for localizing aerial vehicles and, more particularly, to a system including an unmanned vehicle that is used to localize an aerial vehicle.

Some vehicles do not require an onboard human presence and are referred to as unmanned vehicles (e.g., unmanned aerial vehicles (UAV), unmanned ground vehicles (UGV), and unmanned surface vehicles (USV)). The UAVs, UGVs, and USVs are also commonly referred to as drones. For example, drones may be used to access locations that are difficult to access for humans. In addition, drones may provide a reduced size in comparison to manned vehicles because components required to accommodate a human presence, such as a cockpit, are omitted from the drones.

At least some known UAVs provide increased maneuverability, travel at faster speeds, and are able to access more locations in comparison to UGVs or USVs. However, UAVs require precise localization information to reach full operation potential and the localization systems that are incorporated into UAV are limited by size and weight restrictions due to flight requirements of the UAV. As a result, at least some known UAVs are not able to carry localization systems with capabilities that provide the highest accuracy and most complete localization information. Thus, the operability of such UAVs is limited by the capabilities of the onboard localization systems.

At least some known UAVs rely on global positioning system (GPS) information for localization. GPS information can provide accurate localization information with minimal onboard system requirements. However, GPS information is not available in all areas at all times. For example, some UAVs operate indoors where GPS information may be unavailable or unreliable. Accordingly, in at least some locations, stationary beacons are installed to allow the UAV to localize itself in the environment relative to the stationary beacons. However, the stationary beacons require installation at precise locations in the environment before operation of the UAV. Accordingly, stationary beacons are not feasible for at least some locations. In addition, the UAV may lose sight or communication with the stationary beacons as the UAV moves through the environment and, as a result, the available flight paths for the UAV are limited by the locations of the stationary beacons.

Accordingly, there is a need for a system that provides improved localization of UAVs and can be used in environments where global positioning systems are unreliable or unavailable.

### BRIEF DESCRIPTION

In one aspect, a system includes at least one unmanned aerial vehicle and at least one unmanned vehicle communicatively coupled to the at least one unmanned aerial vehicle. The at least one unmanned aerial vehicle includes a propulsion system and an onboard pilot system configured to determine a flight path for the at least one unmanned aerial vehicle. The at least one unmanned vehicle includes a propulsion system and a localization system configured to determine a location of the at least one unmanned aerial vehicle relative to the at least one unmanned vehicle. The at least one unmanned vehicle further includes a communication component configured to transmit location information to the at least one unmanned aerial vehicle. The onboard pilot system is configured to determine the flight path based on the location information provided by the at least one unmanned vehicle.

In another aspect, an unmanned vehicle for localizing an unmanned aerial vehicle is provided. The unmanned vehicle includes a body and a propulsion system. The unmanned vehicle also includes a localization system configured to determine a location of the unmanned aerial vehicle relative to the unmanned vehicle. The unmanned vehicle further includes a communication component configured to transmit location information to the unmanned aerial vehicle. The unmanned vehicle also includes an onboard pilot system configured to determine a path for the unmanned vehicle relative to the unmanned aerial vehicle based on the location of the unmanned aerial vehicle.

In yet another aspect, a method for operating a system including an unmanned aerial vehicle and an unmanned vehicle is provided. The method includes moving the unmanned aerial vehicle and moving the unmanned vehicle. The method also includes determining a location of the unmanned vehicle using a localization system on the unmanned vehicle. The method further includes determining a location of the unmanned aerial vehicle relative to the unmanned vehicle using the localization system on the unmanned vehicle, transmitting location information from the unmanned vehicle to the unmanned aerial vehicle, and determining a flight plan for the unmanned aerial vehicle based on the location information.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of a system for localizing an aerial vehicle using a ground vehicle;

FIG. 2 is a flow diagram of a method for localizing an aerial vehicle using the system shown in FIG. 1;

FIG. 3 is an elevation view of a system including an aerial vehicle and a ground vehicle configured to localize the aerial vehicle; and

FIG. 4 is a schematic diagram of the aerial vehicle and the ground vehicle of the system shown in FIG. 2 navigating relative to an object.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), and application specific integrated circuit (ASIC), and other programmable circuits, and these terms are used interchangeably herein. In the embodiments described herein, “memory” may include, but is not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the exemplary embodiment, additional output channels may include, but not be limited to, an operator interface monitor or heads-up display. Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an ASIC, a PLC, a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

As used herein, the term “aerial vehicle” refers to a vehicle that is configured to fly above the ground. The term “ground vehicle” refers to a vehicle that is configured to travel along the ground while in contact or close proximity to the ground. Some aerial vehicles and ground vehicles do not require an onboard human presence and are referred to as unmanned aerial vehicles (UAV) or unmanned ground vehicles (UGV). As used herein, the term “onboard” refers to a component or system that is present on a vehicle.

Embodiments described herein provide systems and methods for localizing a UAV using a UGV. The UGV includes a detector configured to detect the UAV and a localization system configured to determine relative locations of the UGV and the UAV. The UGV is further configured to transmit location information to the UAV during operation of the UAV and the UGV. The UAV is able to operate using the location information provided by the UGV. For example, the UAV relies on the localization system of the UGV to determine flight plans and is not required to carry a complex localization system. In addition, the UAV is able to operate in environments where GPS information is unavailable or unreliable. Moreover, the system is able to avoid environmental occlusions because the UGV is movable during operation of the UAV and the UGV. Further, the system is portable and configured to operate in locations without requiring setup and installation of stationary beacons.

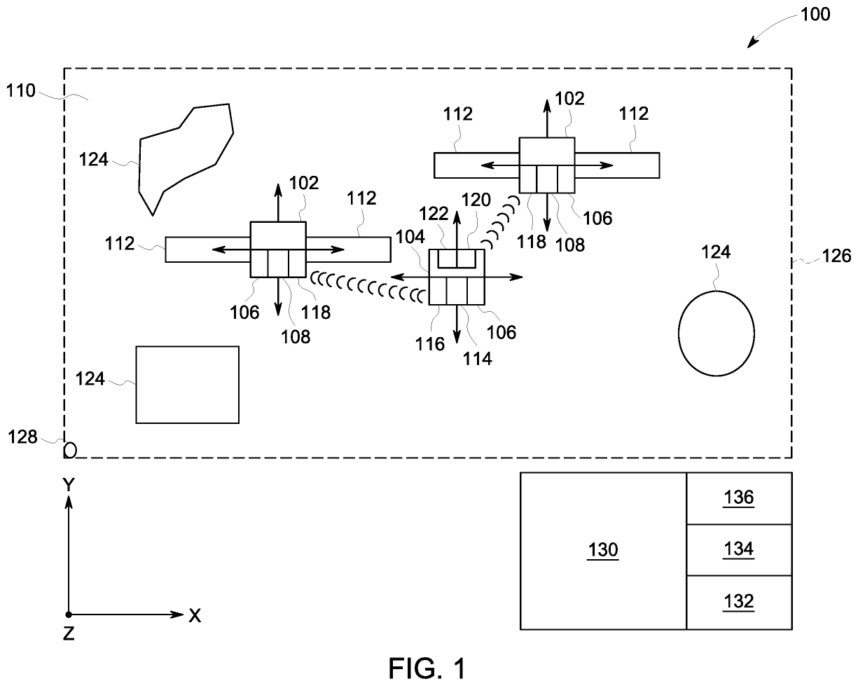

FIG. 1 is a schematic diagram of a system 100 for localizing an aerial vehicle 102 using a ground vehicle 104. FIG. 1 includes a coordinate axis indicating X, Y, and Z directions. In the exemplary embodiment, aerial vehicle 102 and ground vehicle 104 are unmanned, i.e., aerial vehicle 102 and ground vehicle 104 do not require an onboard human presence. In addition, aerial vehicle 102 and ground vehicle 104 each include an automated onboard pilot system 106 which provides at least partially automated steering of aerial vehicle 102 and ground vehicle 104. Automated onboard pilot system 106 of aerial vehicle 102 controls aerial vehicle 102 based on location information provided by ground vehicle 104. Automated onboard pilot system 106 of ground vehicle 104 is configured to determine a path for ground vehicle based on a determined location of ground vehicle 104 and a determined location of unmanned aerial vehicle 102. For example, in some embodiments, ground vehicle 104 follows aerial vehicle 102 and provides location information to aerial vehicle 102 such that ground vehicle 104 and aerial vehicle 102 move around as an autonomous team. In alternative embodiments, aerial vehicle 102 and/or ground vehicle 104 are at least partly controlled from a remote location.

In some embodiments, system 100 includes one or more unmanned surface vehicles (USV) configured to travel over surfaces such as water. System 100 may include USV(s) in place of or in addition to aerial vehicle 102 and/or ground vehicle 104. For example, in some embodiments, at least one USV is configured to identify and localize aerial vehicle 102 and communicate location information to aerial vehicle 102. In alternative embodiments, system 100 includes any vehicle that enables system 100 to operate as described herein.

In the exemplary embodiment, aerial vehicle 102 includes a propulsion system 108 configured to move aerial vehicle 102 relative to a surface 110 at a distance above surface 110. Propulsion system 108 is any propulsion system that enables aerial vehicle 102 to operate as described herein. For example, in some embodiments, propulsion system 108 includes a motor, thrusters, propellers, and/or blades.

Also, in the exemplary embodiment, aerial vehicle 102 includes airfoils 112 which are configured to provide an uplift force when propulsion system 108 provides a propulsive force for aerial vehicle 102. The position of airfoils 112 is adjusted to control the uplift force on aerial vehicle 102 and, thereby, the flight of aerial vehicle 102. In alternative embodiments, aerial vehicle 102 includes any airfoil 112 which enables aerial vehicle 102 to operate as described herein. For example, in some embodiments, airfoils 112 are coupled to propulsion system 108 and propulsion system 108 rotates airfoils 112 to provide the uplift force for aerial vehicle 102. In further embodiments, airfoils 112 are omitted and aerial vehicle 102 includes other suitable flight mechanisms.

In addition, in the exemplary embodiment, ground vehicle 104 includes a propulsion system 114 configured to move ground vehicle 104 relative to surface 110. Propulsion system 114 is any propulsion system that enables ground vehicle 104 to operate as described herein. For example, in some embodiments, propulsion system 114 includes a motor and a drive mechanism such as wheels, treads, tracks, worms, legs, and/or electromagnetic or fluidic locomotion mechanisms.

Also, in the exemplary embodiment, ground vehicle 104 and aerial vehicle 102 are communicatively coupled together and are configured to exchange information. For example, ground vehicle 104 includes a communication component 116 configured to transmit location information to a communication component 118 of aerial vehicle 102. In the exemplary embodiment, communication components 116, 118 are configured to communicate wirelessly using, for example, a local area network, an infrared (IR) communication system, a satellite communication system, radio communication system, and/or a cellular network. In alternative embodiments, ground vehicle 104 and aerial vehicle 102 communicate in any manner that enables system 100 to operate as described herein. For example, in some embodiments, a communication tether or cable extends between and is coupled to ground vehicle 104 and aerial vehicle 102 for communication.

In addition, in the exemplary embodiment, ground vehicle 104 includes a detector 120 and a localization system 122. Detector 120 is configured to detect aerial vehicle 102 and objects 124 within environment 126. Detector 120 includes any detector that enables system 100 to operate as described herein. For example, in some embodiments, detector 120 includes a light detection and ranging (LIDAR) device, a camera, an infrared device, an eddy current sensor, a sonar device, a radar device, a global positioning system (GPS) device, a simultaneous localization and mapping (SLAM) device, a gyroscope, an accelerometer, and/or any other positioning sensor. In some embodiments, detector 120 is incorporated into localization system 122.

Also, in the exemplary embodiment, ground vehicle 104 is configured to identify aerial vehicle 102 based on information from detector 120 and/or localization system 122. In some embodiments, aerial vehicle 102 includes one or more beacons that emit a signal. In such embodiments, detector 120 receives the signal and identifies aerial vehicle 102 based on the signal. In alternative embodiments, ground vehicle 104 is configured to detect and identify aerial vehicle 102 in any manner that enables system 100 to operate as described herein. For example, in some embodiments, aerial vehicle 102 performs an action or motion that is communicated to ground vehicle 104 and allows ground vehicle 104 to identify aerial vehicle 302. In further embodiments, ground vehicle 104 identifies aerial vehicle 102 based on the position of aerial vehicle 102 relative to the surface and/or other aerial vehicles 102. For example, in some embodiments, ground vehicle 104 identifies aerial vehicle 102 based on an order of takeoff of aerial vehicles 102.

Moreover, in the exemplary embodiment, system 100 includes a plurality of aerial vehicles 102. The plurality of aerial vehicles 102 allow system 100 to operate more efficiently than if system 100 included a single aerial vehicle 102 because aerial vehicles 102 may perform tasks simultaneously. In addition, in the exemplary embodiment, localization system 122 of ground vehicle 104 is configured to determine a location of each aerial vehicle 102 relative to ground vehicle 104. Communication component 116 is configured to transmit location information to communication component 118 of the respective aerial vehicles 102. In some embodiments, each aerial vehicle 102 emits distinct signals to allow ground vehicle 104 to distinguish aerial vehicles 102 from each other and from objects 124. In alternative embodiments, system 100 includes any aerial vehicle 102 and/or ground vehicle 104 that enables system 100 to operate as described herein. For example, in some embodiments, system 100 includes a plurality of ground vehicles 104. In such embodiments, the plurality of ground vehicles 104 may allow localization of aerial vehicles 102 over a larger area than a system including a single ground vehicle 104.

Moreover, in the exemplary embodiment, localization system 122 is configured to determine a location of ground vehicle 104, determine a location of each aerial vehicle 102 relative to ground vehicle 104, and relate the location of ground vehicle 104 and the location of each aerial vehicle 102 to a common origin 128. In the exemplary embodiment, localization system 122 includes, for example and without limitation, a global positioning system (GPS) device, an inertial measurement unit (IMU), a light detection and ranging (LIDAR) device, a camera, an infrared device, an eddy current sensor, a sonar device, a radar device, and/or any other positioning sensor. In alternative embodiments, system 100 includes any localization system 122 that enables system 100 to operate as described herein.

In some embodiments, localization system 122 generates a spatial 3-D model of environment 126 including the locations of ground vehicle 104 and aerial vehicles 102. In addition, in some embodiments, the spatial model includes objects 124. Ground vehicle 104 may communicate the spatial model or a portion of the spatial model to aerial vehicles 102. In the exemplary embodiment, localization system 122 is configured to provide simultaneous localization and mapping (SLAM). In addition, in some embodiments, ground vehicle 104 and/or aerial vehicle 102 includes a GPS component configured to provide high fidelity GPS information when GPS is available. However, in the exemplary embodiment, ground vehicle 104 is able to determine localization information for aerial vehicle 102 and environment 126 around aerial vehicle 102 without the use of GPS. Accordingly, system 100 is configured to operate in locations where GPS is limited or unavailable.

In addition, in the exemplary embodiment, aerial vehicle 102 is configured to determine flight plans based on the location information received from ground vehicle 104. For example, aerial vehicle 102 determines a flight path around objects 124 based on the location information received from ground vehicle 104. The onboard processing and sensing requirements for aerial vehicle 102 are reduced because ground vehicle 104 allows aerial vehicle 102 to determine the flight plan based on the localization information provided by ground vehicle 104. Also, the accuracy and precision of the flight plan is increased because ground vehicle 104 provides localization information that is more detailed and precise than localization information that aerial vehicle 102 could generate with onboard systems, at least in part because ground vehicle 104 is not subject to the size and weight restrictions of aerial vehicle 102.

In some embodiments, system 100 includes a controller 130 that is communicatively coupled to aerial vehicles 102 and ground vehicle 104. Controller 130 includes a processor 132, a memory 134, and a user interface 136. Controller 130 is configured to determine and/or store localization information provided by ground vehicle 104. In addition, user interface 136 allows presentation of information to a user and allows a user to input information for system 100. In some embodiments, user interface 136 is able to be used to at least partially steer or direct at least one of aerial vehicles 102 and/or ground vehicle 104. In alternative embodiments, system 100 includes any controller 130 that enables system 100 to operate as described herein. For example, in some embodiments, controller 130 is at least partially incorporated into ground vehicle 104 and/or aerial vehicle 102.

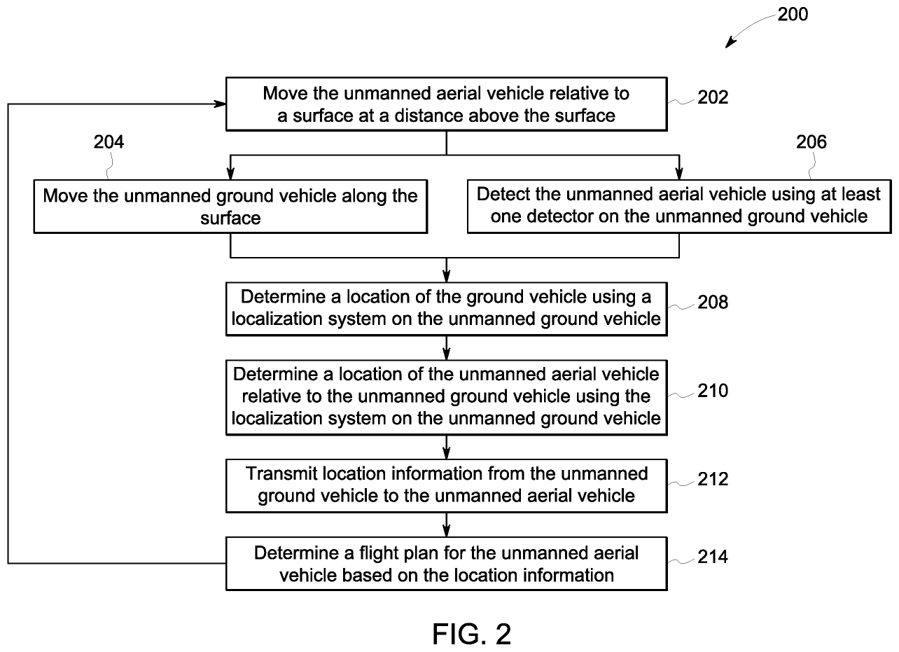

FIG. 2 is a flow diagram of an exemplary method 200 for localizing aerial vehicle 102 using system 100 (shown in FIG. 1). In reference to FIGS. 1 and 2, method 200 includes moving 202 aerial vehicle 102 relative to surface 110 at a distance above surface 110. Aerial vehicle 102 moves in at least one of the X-direction, the Y-direction, and the Z-direction. In some embodiments, a plurality of aerial vehicle 102 are moved relative to surface 110. In alternative embodiments, aerial vehicle 102 is moved in any manner that enables system 100 to operate as described herein.

In addition, in the exemplary embodiment, method 200 includes moving 204 ground vehicle 104 along surface 110. For example, propulsion system 108 is used to propel ground vehicle 104 along surface 110 while ground vehicle 104 is in contact with or close proximity to surface 110. Ground vehicle 104 moves in at least one of the X-direction, the Y-direction, and the Z-direction. In some embodiments, a plurality of ground vehicle 104 are moved relative to surface 110. In alternative embodiments, ground vehicle 104 is moved in any manner that enables system 100 to operate as described herein.

Also, in the exemplary embodiment, method 200 includes detecting 206 aerial vehicle 102 using detector 120 on ground vehicle 104. Ground vehicle 104 is configured to detect aerial vehicle 102 as ground vehicle 104 and aerial vehicle 102 move relative to surface 110. In some embodiments, ground vehicle 104 uses an iterative process to detect aerial vehicle 102 at regular intervals. In further embodiments, ground vehicle 104 continuously detects aerial vehicle 102 to provide a continuous stream of locations of aerial vehicle 102. In alternative embodiments, ground vehicle 104 detects aerial vehicle 102 in any manner that enables system 100 to operate as described herein.

Moreover, in the exemplary embodiment, method 200 includes determining 208 a location of ground vehicle 104 using localization system 122 on ground vehicle 104. For example, localization system 122 identifies landmarks or known locations in environment 126 and determines the location of ground vehicle 104 relative to the landmarks. In addition, in the exemplary embodiment, method 200 includes determining 210 a location of aerial vehicle 102 relative to ground vehicle 104 using localization system 122 on ground vehicle 104. When aerial vehicle 102 is detected, ground vehicle 104 identifies aerial vehicle 102 and determines a position of aerial vehicle 102 relative to ground vehicle 104. For example, in some embodiments, ground vehicle 104 measures a distance between aerial vehicle 102 and ground vehicle 104 in at least one of the X-direction, the Y-direction, and the Z-direction. In addition, in some embodiments, ground vehicle 104 determines an attitude, such as the roll, pitch, and/or yaw, of aerial vehicle 102 relative to the X-axis, the Y-axis, and/or the Z-axis. Accordingly, ground vehicle 104 is able to determine the position of aerial vehicle 102 in the global coordinate system based on the position of aerial vehicle 102 relative to ground vehicle 104 and the determined location of ground vehicle 104. In alternative embodiments, the position of aerial vehicle 102 is determined in any manner that enables system 100 to operate as described herein.

For example, in some embodiments, localization system 122 generates a local coordinate system based on the location of ground vehicle 104 and determines coordinates of aerial vehicle 102 relative to ground vehicle 104. In addition, localization system 122 provides locations of objects 124 relative to ground vehicle 104. In further embodiments, ground vehicle 104 builds a complete spatial map of environment 126 which includes aerial vehicle 102, ground vehicle 104, and objects 124 in environment 126 relative to a global coordinate system. Localization system 122 may determine the location of aerial vehicle 102 relative to the global coordinate system by multiplying a scalar value representing the position of aerial vehicle 102 relative to ground vehicle 104 and the position of ground vehicle 104 on the global coordinate system. The location and orientation of aerial vehicle 102, ground vehicle 104, and objects in the selected coordinate system may be continuously updated as aerial vehicle 102 and ground vehicle 104 move through environment 126. In alternative embodiments, localization system 122 generates any location information that enables system 100 to operate as described herein.

Also, in the exemplary embodiment, method 200 includes transmitting 212 location information from ground vehicle 104 to aerial vehicle 102. For example, in some embodiments, ground vehicle 104 transmits the local coordinate system and the location of aerial vehicle 102 relative to the local coordinate system to aerial vehicle 102. In further embodiments, ground vehicle 104 transmits the location of aerial vehicle 102 relative to the global coordinate system. In some embodiments, ground vehicle 104 transmits the location of one or more objects 124 in environment 126 to aerial vehicle 102. In alternative embodiments, ground vehicle 104 transmits any information to aerial vehicle 102 that enables ground vehicle 104 to operate as described herein.

Moreover, in the exemplary embodiment, method 200 includes determining 214 a flight plan for aerial vehicle 102 based on the location information. The flight plan may be determined by aerial vehicle 102 and/or ground vehicle 104. In the exemplary embodiment, onboard pilot system 106 of aerial vehicle 102 determines the flight plan based on the location information from ground vehicle 104. For example, the flat plan may include a flight path relative to obstacles in environment 126. In alternative embodiments, system 100 determines the flight plan for aerial vehicle 102 in any manner that enables system 100 to operate as described herein. For example, in some embodiments, ground vehicle 104 determines at least a portion of the flight plan and provides the flight plan to aerial vehicle 102.

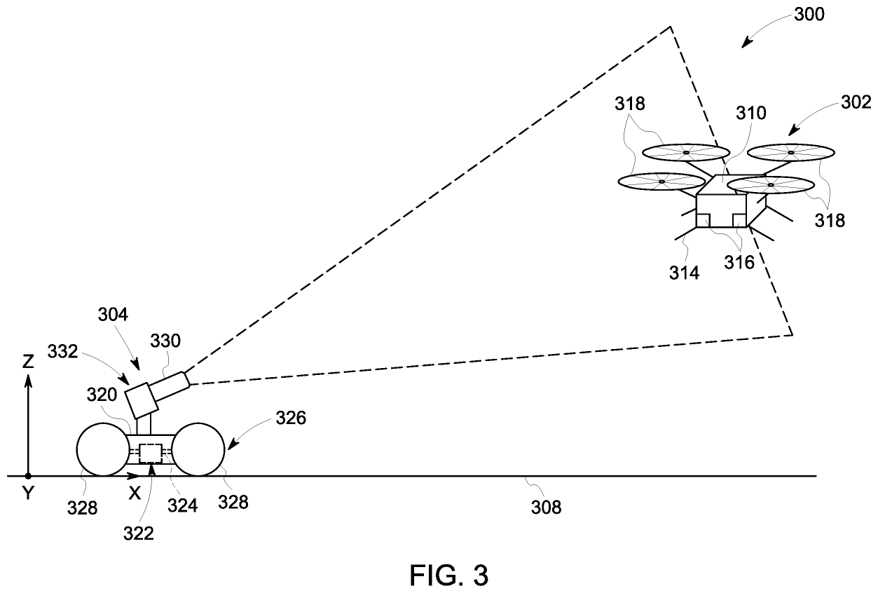

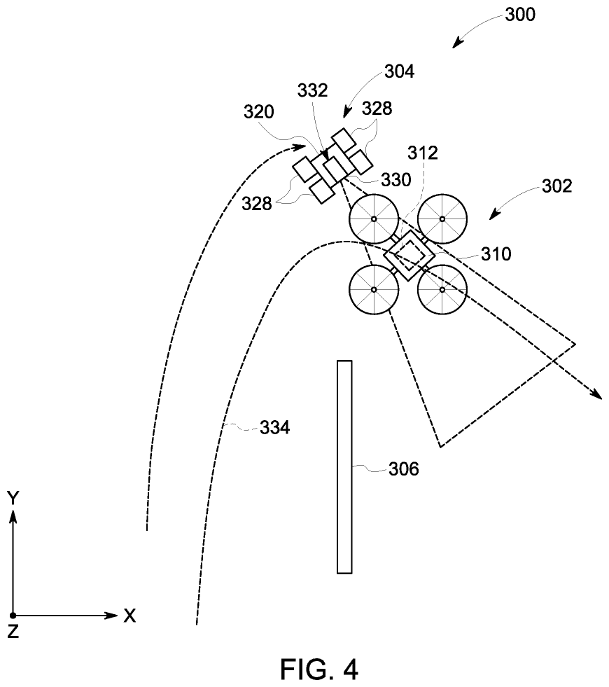

FIG. 3 is an elevation view of a system 300 including an aerial vehicle 302 and a ground vehicle 304 configured to localize aerial vehicle 302. FIG. 4 is a schematic diagram of aerial vehicle 302 and ground vehicle 304 of system 300 navigating relative to an object 306. FIGS. 3 and 4 include a coordinate axis indicating X, Y, and Z directions. Ground vehicle 304 is configured to move in the X, Y, and Z directions while traveling along a surface 308. Aerial vehicle 302 is configured to move in the X, Y, and Z directions while flying above surface 308. In alternative embodiments, aerial vehicle 302 and ground vehicle 304 are configured to move in any manner that enables system 300 to operate as described herein.

In the exemplary embodiment, aerial vehicle 302 includes a body 310, a propulsion system 312, landing gear 314, and beacons 316. Propulsion system 312 includes a motor (not shown) and a plurality of drive mechanisms 318. In the exemplary embodiment, drive mechanisms 318 comprise rotor blades that are rotated by the motor to provide an uplift force for aerial vehicle 302. In addition, propulsion system 312 is a differential propulsion system and is capable of rotating each rotor blade at a different speed from the rotational speed of other blades and in multiple directions (i.e., clockwise or counterclockwise). Accordingly, propulsion system 312 is able to control the direction of movement of aerial vehicle 302 in the X, Y, and Z directions. A power source (not shown), such as a battery, provides power for operation of propulsion system 312 and any other components of aerial vehicle 302. In alternative embodiments, aerial vehicle 302 includes any propulsion system 312 that enables aerial vehicle 302 to operate as described herein. For example, in some embodiments, propulsion system 312 includes a drive mechanism other than rotor blades, such as thrusters.

Also, in the exemplary embodiment, ground vehicle 304 further includes a body 320 and a propulsion system 322 configured to move ground vehicle 304 along surface 308. Propulsion system 322 includes a motor 324 and a plurality of drive mechanisms 326. Motor 324 is coupled to and drives drive mechanisms 326 to propel ground vehicle 304 in at least one of the X-direction, the Y-direction, and the Z-direction. Specifically, in the exemplary embodiment, drive mechanisms 326 include wheels 328 that contact surface 308 and propel ground vehicle 304 along surface 308 as motor 324 rotates wheels 328. In some embodiments, propulsion system 322 is a differential propulsion system 322 and is capable of rotating each wheel 328 at a speed different from the rotational speed of the other wheels 328 and in multiple directions (i.e., clockwise or counterclockwise). A power source (not shown), such as a battery, provides power for operation of motor 324 and any other components of ground vehicle 304. In alternative embodiments, ground vehicle 304 includes any propulsion system 322 that enables ground vehicle 304 to operate as described herein. For example, in some embodiments, propulsion system 322 includes a drive mechanism other than wheels, such as treads, tracks, worms, legs, and/or electromagnetic for fluidic locomotion mechanisms.

Moreover, in the exemplary embodiment, ground vehicle 304 includes at least one detector 330 configured to detect aerial vehicle 302. Detectors 330 include, for example and without limitation, a LIDAR device, a camera, an infrared device, an ultrasound sensor, a sonar device, a radar device, and/or any other sensor. In alternative embodiments, ground vehicle 304 includes any detector 330 that enables ground vehicle 304 to operate as described herein.

Moreover, in the exemplary embodiment, ground vehicle 304 includes a localization system 332 configured to determine a location of ground vehicle 304 and aerial vehicle 302. In the exemplary embodiment, localization system 332 includes, for example and without limitation, a global positioning system (GPS) device, an inertial measurement unit (IMU), a light detection and ranging (LIDAR) device, a camera, an infrared device, an eddy current sensor, a sonar device, a radar device, and/or any other positioning sensor. Accordingly, localization system 332 enables steering of ground vehicle 304 and/or facilitates determining positions of aerial vehicle 302. In alternative embodiments, ground vehicle 304 includes any localization system 332 that enables system 300 to operate as described herein.

Also, in the exemplary embodiment, ground vehicle 304 is configured to determine a position of aerial vehicle 302. For example, ground vehicle 304 detects aerial vehicle 302 and determines the location of aerial vehicle 302 relative to ground vehicle 304. Accordingly, ground vehicle 304 is able to generate a map including locations of ground vehicle 304 and aerial vehicle 302 relative to a common origin.

In addition, in some embodiments, ground vehicle 304 is configured to relate the determined position of aerial vehicle 302 to a coordinate system of the environment. For example, ground vehicle 304 is configured to determine a location of at least one landmark in the environment relative to ground vehicle 304. Ground vehicle 304 is configured to relate the determined position of aerial vehicle 302 to a coordinate system of the environment based on the location of ground vehicle 304 and the landmark.

Moreover, in the exemplary embodiment, aerial vehicle 302 and/or ground vehicle 304 is further configured to determine a flight path 334 for aerial vehicle 302 based on the location of aerial vehicle 302 determined by ground vehicle 304 and any other operating parameter of system 300 and/or detected characteristic of the environment. For example, during operation of system 300, aerial vehicle 302 receives location information from ground vehicle 304 including the location of objects 306 relative to aerial vehicle 302. As a result, aerial vehicle 302 is able to determine flight path 334 relative to objects 306. The computational and system requirements for aerial vehicle 302 are reduced because aerial vehicle 302 is not required to detect and locate objects 306 using onboard systems. Accordingly, aerial vehicle 302 does not require sensing equipment for locating objects 306 in the environment. In some embodiments, flight path 334 for aerial vehicle 302 is determined prior to movement of aerial vehicle 302. In further embodiments, flight path 334 is determined at least partly in real-time as aerial vehicle 302 and/or ground vehicle 304 is moved within the environment.

Also, in the exemplary embodiment, aerial vehicle 302 includes at least one beacon 316 configured to emit a unique signal. For example, in some embodiments, beacons 316 emit pulsed lights and/or sounds and the pulse pattern are detectable by detector 330 of ground vehicle 304. Ground vehicle 304 is configured to identify aerial vehicle 302 based on the signal emitted by beacon 316. In alternative embodiments, ground vehicle 304 is configured to identify aerial vehicle 302 in any manner that enables system 300 to operate as described herein. For example, in some embodiments, aerial vehicle 302 includes a passive indicator that allows ground vehicle 304 to identify aerial vehicle 302. In further embodiments, aerial vehicle 302 performs an action or motion that is communicated to ground vehicle 304 and allows ground vehicle 304 to identify aerial vehicle 302. In some embodiments, ground vehicle 304 identifies aerial vehicle 302 based on the position of aerial vehicle 302 relative to the surface and/or other aerial vehicles 302. In such embodiments, beacon 316 may be omitted.

An exemplary technical effect of the methods, systems, and apparatus described herein includes at least one of: (a) reducing the size and weight of aerial vehicles; (b) increasing the accuracy of localization of aerial vehicles; (c) increasing the payload capacity of aerial vehicles; (d) increasing the mission duration of aerial vehicles; (e) providing systems with aerial vehicles that are able to operate in larger environments without GPS accessibility; and (f) increasing the accuracy and reliability of flight planning for aerial vehicles.

Exemplary embodiments of methods, systems, and apparatus for locating vehicles are not limited to the specific embodiments described herein, but rather, components of systems and/or steps of the methods may be utilized independently and separately from other components and/or steps described herein. For example, the methods, systems, and apparatus may also be used in combination with other systems requiring localization of vehicles, and are not limited to practice with only the systems and methods as described herein. Rather, the exemplary embodiment can be implemented and utilized in connection with many other applications, equipment, and systems that may benefit from using a first vehicle to localize a second vehicle.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
at least one unmanned aerial vehicle comprising:
a propulsion system; and
an onboard pilot system configured to determine a flight path for said at least one unmanned aerial vehicle; and
at least one unmanned vehicle configured to be communicatively coupled to said at least one unmanned aerial vehicle, said at least one unmanned vehicle comprising:
a propulsion system;
a localization system configured to determine a location of said at least one unmanned aerial vehicle relative to said at least one unmanned vehicle; and
a communication component configured to transmit location information to said at least one unmanned aerial vehicle, wherein said onboard pilot system is configured to determine the flight path based on the location information provided by said at least one unmanned vehicle.

2. The system in accordance with claim 1, wherein said localization system is further configured to determine a location of said at least one unmanned vehicle and relate the location of said at least one unmanned vehicle and the location of said at least one unmanned aerial vehicle to a common origin, and wherein the location information includes the location of said at least one unmanned vehicle and the location of said at least one unmanned aerial vehicle relative to the common origin.

3. The system in accordance with claim 2, wherein said at least one unmanned vehicle further includes an onboard pilot system configured to determine a path for said at least one unmanned vehicle relative to said at least one unmanned aerial vehicle based on the location of said at least one unmanned aerial vehicle.

4. The system in accordance with claim 1, wherein said propulsion system of said at least one unmanned vehicle includes a plurality of drive mechanisms, and a motor coupled to said plurality of drive mechanisms.

5. The system in accordance with claim 1 further comprising a plurality of unmanned aerial vehicles, wherein said localization system is configured to determine a location of each unmanned aerial vehicle of said plurality of unmanned aerial vehicles relative to said at least one unmanned vehicle, and wherein said communication component is configured to transmit location information to each said unmanned aerial vehicle of said plurality of unmanned aerial vehicles.

6. The system in accordance with claim 1, wherein said localization system is further configured to detect objects, and wherein said communication component is configured to transmit, to said at least one unmanned aerial vehicle, locations of the objects relative to said at least one unmanned aerial vehicle.

7. The system in accordance with claim 1, wherein said at least one unmanned aerial vehicle includes a beacon configured to emit a signal, and wherein said at least one unmanned vehicle is configured to identify said at least one unmanned aerial vehicle based on the signal emitted by said beacon.

8. The system in accordance with claim 1, wherein said at least one unmanned aerial vehicle and said at least one unmanned vehicle are communicatively coupled by a wireless communication system such that said at least one unmanned vehicle and said at least one unmanned aerial vehicle communicate using the wireless communication system, and wherein said at least one unmanned aerial vehicle is configured to receive location information from said at least one unmanned vehicle that is not based on global positioning system information.

9. An unmanned vehicle for localizing an unmanned aerial vehicle, said unmanned vehicle comprising:
a body;
a propulsion system;
a localization system configured to determine a location of the unmanned aerial vehicle relative to said unmanned vehicle;
a communication component configured to transmit location information to the unmanned aerial vehicle; and
an onboard pilot system configured to determine a path for the unmanned vehicle relative to the unmanned aerial vehicle based on the location of the unmanned aerial vehicle.

10. The unmanned vehicle in accordance with claim 9, wherein said propulsion system includes a plurality of drive mechanisms and a motor coupled to said plurality of drive mechanisms.

11. The unmanned vehicle in accordance with claim 9, wherein the location information includes the location of the unmanned aerial vehicle and said unmanned vehicle relative to a common origin, and wherein the unmanned aerial vehicle is able to use the location information to generate a flight plan.

12. The unmanned vehicle in accordance with claim 9, further comprising at least one detector configured to detect objects in a path of the unmanned aerial vehicle, and wherein said communication component is configured to transmit locations of the objects to the unmanned aerial vehicle.

13. The unmanned vehicle in accordance with claim 9, wherein the unmanned aerial vehicle includes a beacon configured to emit a signal, and wherein said unmanned vehicle is configured to identify the unmanned aerial vehicle based on the signal emitted by the beacon.

14. The unmanned vehicle in accordance with claim 9, wherein the unmanned aerial vehicle and said unmanned vehicle are communicatively coupled by a wireless communication system such that said unmanned vehicle and the unmanned aerial vehicle communicate over the wireless communication system, and wherein said unmanned vehicle is configured to provide location information to the unmanned aerial vehicle that is not based on global positioning system information.

15. A method for operating a system including an unmanned aerial vehicle and an unmanned vehicle, said method comprising:
moving the unmanned aerial vehicle;
moving the unmanned vehicle;
determining a location of the unmanned vehicle using a localization system on the unmanned vehicle;
determining a location of the unmanned aerial vehicle relative to the unmanned vehicle using the localization system on the unmanned vehicle;
transmitting location information from the unmanned vehicle to the unmanned aerial vehicle; and
determining a flight plan for the unmanned aerial vehicle based on the location information.

16. The method in accordance with claim 15 further comprising detecting at least one object using at least one detector, and wherein determining a flight plan for the unmanned aerial vehicle based on the location information comprises determining a flight path for the unmanned aerial vehicle based on the location of an obstacle and the location of the unmanned aerial vehicle.

17. The method in accordance with claim 15 further comprising determining a path for the unmanned vehicle using an onboard pilot system.

18. The method in accordance with claim 15, wherein moving the unmanned vehicle comprises driving a plurality of drive mechanisms using a motor coupled to the plurality of drive mechanisms.

19. The method in accordance with claim 15 further comprising:
determining a location of a second unmanned aerial vehicle relative to the unmanned vehicle using the localization system on the unmanned vehicle;
transmitting location information from the unmanned vehicle to the second unmanned aerial vehicle; and
determining a flight plan for the second unmanned aerial vehicle based on the location information.

20. The method in accordance with claim 15 further comprising emitting a signal from a beacon of the unmanned aerial vehicle, and wherein the unmanned vehicle is configured to identify the unmanned aerial vehicle based on the signal emitted by the beacon.
